(19) United States
(12) Patent Application Publication
(10) Pub. No.: US 2002/0010566 A1
(43) Pub. Date: Jan. 24, 2002

(54) Methods for modeling, predicting, and optimizing high performance liquid chromatography parameters

(76) Inventors: Thomas Lee Chester, Cincinnati, OH (US); Jianjun Li, West Chester, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(21) Appl. No.: 09/777,989

(22) Filed: Feb. 6, 2001

Related U.S. Application Data
(60) Provisional application No. 60/196,184, filed on Apr. 11, 2000.

(51) Int. Cl. G06F 17/10

(52) U.S. Cl. 703/2

(57) ABSTRACT

A method for modeling high performance liquid chromatography parameters is disclosed. The method can predict retention times, peak widths, and resolution. The method can also perform a multivariate optimization of a separation over two or more user-adjustable parameters. The method can be applied to isocratic and gradient separations and any combination of isocratic and gradient conditions.

### FIELD OF THE INVENTION

This invention relates to methods for predicting liquid chromatography (“LC”) separations and optimizing LC parameters. More particularly, this invention relates to methods for modeling retention times and peak widths; predicting retention times, peak widths, and resolution; and performing a multivariate optimization of the separation over more than one user-adjustable parameter. The methods are applicable to isocratic and gradient separations and any combination of isocratic and gradient conditions.

### BACKGROUND OF THE INVENTION

### Liquid Chromatography Techniques

Liquid chromatography (“LC”) is an analytical technique used to separate compounds (“solutes”) that are transported in a liquid “mobile phase”. A solution, comprising the solutes and an appropriate solvent, is brought into contact with a stationary phase packed in or coated on a column. Mobile phase is then passed through the column. Different compounds in the solution pass through the column at different rates due to differences in their interactions between the mobile phase and the stationary phase and are thereby separated. The solutes may either be quantitated, identified, or both, using a suitable detector, as they elute from the column outlet. A plot of detector signal against time is called a chromatogram. The solutes may also be collected, if desired, by diverting the effluent into collection vessels as the solutes of interest exit the column or detector.

High performance liquid chromatography (“HPLC”) is an LC method that uses very small stationary phase particles or a porous, monolithic stationary phase and a pump to force the mobile phase through the column. HPLC provides higher resolution and faster analysis time than earlier LC methods. There are two principal types of HPLC: normal-phase HPLC and reversed-phase HPLC. Normal-phase HPLC uses a relatively polar stationary phase, for example, silica, and a low-polarity solvent, such as n-hexane, methylene chloride, or ethyl acetate, or mixtures of such solvents, as the mobile phase. When the mobile phase is a mixture of two solvents, the solvent which dissolves the solutes more poorly will be referred to as the weak or the main component, and the solvent which dissolves the solutes more strongly will be referred to as the strong component or the modifier. The overall strength of the mobile-phase solution can be adjusted continuously by changing the relative amounts of the weak and strong components. Reversed-phase HPLC uses a relatively nonpolar stationary phase, for example, silica with surface-bound octadecylsilyl groups, and a more-polar mobile phase, such as water, methanol, acetonitrile, tetrahydrofuran, or mixtures of these solvents. Water is often used as the main component, and methanol, acetonitrile, or tetrahydrofuran is used as the modifier. More complicated mobile phases, such as ternary, quaternary, or higher-order mixtures may also be used. Buffers and other additives may also be used in the mobile phase to control pH or ionic strength, to enhance or prevent solute retention mechanisms, or to interact with some or all of the solutes or the stationary phase in specific ways that improve the separation.

FIG. 1 represents a schematic diagram of a typical analytical-scale HPLC system. Pump 100 pumps a weak component from a weak component supply 90, and pump 105 pumps a strong component from a strong component supply 95, to the mixer 110. The mixer 110 ensures that the components are uniformly mixed when they reach the injector 115. The resulting solvent mixture exiting the mixer 110 is the mobile phase.

A sample comprising solutes is introduced into the mobile phase at injector 115. The resulting solution comprising the sample and mobile phase moves through the inlet 120 into the HPLC column 125. As the solution passes through the column 125, the solutes in the sample separate. The column effluent comprising the mobile phase and solutes exits the column at outlet 130 and passes through the detector 140. The presence of solutes in the column effluent is recorded by the detector 140. The detector 140 functions by, for example, detecting a change in refractive index, UV-VIS absorption at a set wavelength or at multiple wavelengths, fluorescence after excitation with light of a suitable wavelength, or electrochemical response. Mass spectrometers can also be interfaced with IPLC instruments to help identify the separated solutes by providing information on the chemical structure. The column effluent can be collected, if desired, in receiver 145.

Each solute moves through the column at a particular velocity because the solutes interact to different extents with the stationary phase. Furthermore, the solutes will tend to interact more strongly with the stationary phase when the mobile phase is primarily weak because the solutes are poorly soluble in weak solvents and thereby interact to a greater extent with the stationary phase. Similarly, the solutes will tend to interact less with the stationary phase when the mobile phase is primarily strong because the solutes are more soluble in strong solvents.

### Methods for Developing Chromatography Protocols

HPLC systems are used in analytical, preparative, and production scale processes, for example, to analyze the composition of samples of unknown purity or to remove impurities and purify desired products. In the past, a typical procedure to develop an HPLC protocol consisted of performing many experiments in a trial and error approach. The trial and error approach involved varying the important, user-adjustable parameters one at a time (i.e., one in each experiment) until adequate resolution between all solute peaks of interest was achieved in a reasonable amount of time. The parameters include, for example, column length and diameter, particle size of the stationary phase, mobile phase flow rate, modifier concentration in the mobile phase, and many more. Applying the trial and error approach to a system with many variables, such as HPLC, is time consuming and expensive because it requires extensive use of resources to perform many laboratory experiments. Developing a protocol that provides an adequate separation, which is not at all optimized, often can take several weeks using this approach.

Mathematical modeling of HPLC chromatograms can be used to expedite this procedure somewhat. HPLC chromatograms can be mathematically modeled from experimental data collected with different values of the user-adjustable parameters. Once a model is developed, chromatograms may be predicted by changing the values of the modeled parameters and calculating the expected chromatogram. By generating a model from initial laboratory experiments, chromatograms can be predicted using fewer experiments than the trial and error approach. However, using the models described below does not obviate the need for significant further experimentation. Inaccuracies in the models create the need for more experiments to verify and fine tune the results. Furthermore, none of the models below is capable of performing a multivariate optimization where more than two operational parameters are varied concurrently. Therefore, even with the use of a predictive mathematical model, further laboratory experiments are required to obtain a local optimum for the separation.

Therefore, it is an object of this invention to provide a method for modeling, predicting, and optimizing HPLC separations that dramatically reduces the time, resources, and number of laboratory experiments required to develop an HPLC protocol. It is a further object of the invention to provide a method for developing a globally optimized HPLC protocol that can be carried out in less than one day, using as few as 2 to 4 laboratory experiments.

### Methods for Modeling Chromatography Separations

One method for modeling chromatograms is the time segmented numerical estimation approach. See R. D. Smith, E. G. Chapman, and B. W. Wright, “Pressure Programming in Supercritical Fluid Chromatography,” Analytical Chemistry 57: (14) pp. 2829-2836 (1985) and H. Snijders, H. G. Janssen, and C. Cramers, “Optimization of temperature-programmed gas chromatographic separations. 1. Prediction of retention times and peak widths from retention indices,” Journal of Chromatography A, 718: (2) pp. 339-355 (Dec. 22, 1995). In the time segmented numerical estimation approach, the time allowed for the chromatogram is divided into segments. In each time segment the distance a solute travels is calculated and added to the immediately preceding result to determine how far the solute has traveled along the column since injection. At the end of each time segment, this total distance that a solute has traveled is compared with the total column length to determine if the solute has passed the column outlet. If not, the process continues with the next and subsequent time segments until the solute does elute. When the segment is found in which the solute is calculated to have passed the column outlet, an estimate of the retention time can be made by interpolation in this time segment.

Each solute is represented as a band or peak on a chromatogram. The width of a solute peak may be expressed equivalently in terms of the mobile phase volume (adjusted for retention) it occupies, the distance it occupies along the direction of the column axis, or the time it takes to pass by a reference point. The contribution of each time segment to the width of each solute peak can be calculated. In isocratic HPLC these width contributions may be appropriately combined (as the square root of the sum of their squares) to determine the width of each solute peak when it reaches the column outlet. However, the combination of width contributions, as just described, is not valid when the mobile-phase composition changes in the course of a separation.

The mobile-phase composition can be strengthened during the course of the separation by increasing the concentration of modifier relative to the main component thereby reducing the retention of all the solutes contacting this new mobile phase. This procedure is called gradient elution. These changes may be made, as a function of time, continuously in either a linear or nonlinear fashion, or may be done step-wise. Thus, the mobile-phase composition at any point in the system is time-dependent when a gradient is programmed since the specific changes in the mobile phase are made at specific times.

Whenever any change in mobile phase composition is generated at the mixer according to a gradient program, the effect of this change at locations on the column is delayed by the time necessary to transport the new mobile phase from the mixer to those locations. Therefore, the effects of such a change are first realized at the column inlet, but further delay is required to transport the new mobile phase to points on the column downstream from the inlet. Because of these differences in the time to deliver new mobile phase to different locations on the column, the mobile phase composition at points on the column depends on the distance from the column inlet. Thus, in addition to the temporal dependency mentioned earlier, there is a spatial dependence on the mobile phase strength along an HPLC column when a gradient is programmed.

As a solute peak moves through the column, it tends to broaden due to known factors such as eddy diffusion and others. See J. C. Giddings, Unified Separation Science, John Wiley & Sons, Inc. New York (1991). However, while a peak is in the midst of a continuous mobile phase gradient, the leading edge of the peak is exposed to weaker mobile phase than is the tailing edge of the same peak. Thus, in the absence of peak broadening phenomena, the velocity of the trailing edge relative to the mobile phase would be faster than that of the leading edge. This phenomenon is referred to as “peak compression” due to the spatial component of the gradient.

None of the methods known in the art for modeling HPLC by the method of time segmented numerical estimation are capable of modeling the peak compression caused by gradients. Therefore, it is an object of this invention to provide a method for modeling HPLC column behavior, and predicting chromatograms resulting from parameter changes, that is more accurate and more flexible than previous methods. It is a further object of this invention to combine the inherent benefits of the time segmented numerical estimation approach with an appropriate correction for peak compression. It is a further object of this invention to provide a method applicable to any mobile phase program including total isocratic conditions (which corresponds to a condition of zero rate of mobile-phase change), linear gradients, non-linear gradients of any shape, step-wise changes in mobile phase composition, and all possible combinations of these conditions.

Other methods for modeling HPLC chromatograms are based on empirical rules relating peak width to operational parameters (instead of a numerical method such as the time segmented numerical estimation described above). See, for example, R. G. Wolcott, J. W. Dolan, and L. R. Snyder, “Computer simulation for the convenient optimization of isocratic reversed-phase liquid chromatographic separations by varying temperature and mobile phase strength,” Journal of Chromatography A, 869, pp. 3-25 (2000).

However, these modeling methods also suffer from the drawback that they do not actively correct for peak compression but rely on a correlation between peak width and estimated retention factor at the column outlet. Additional empirical corrections may also be applied. These modeling methods are less accurate than the time segmented numerical estimation approach because they are based on algebraic approximations and empirical expectations. These modeling methods provide limited information in that only the conditions at the column outlet can be predicted. Therefore, it is a further object of this invention to provide a method for predicting HPLC separations that can be used to model conditions at all locations within the column.

### Methods for Optimizing Chromatography Separations

All of the above methods for modeling and optimizing HPLC separations suffer from the additional drawback that they have only been used to determine the apparent optimal value for one or two parameters while all others are fixed. For example, using known modeling methods, the modifier concentration may be optimized in an isocratic model for fixed values of the column dimensions and flow rate. The fault in this approach is that the apparent optimum for the first parameter may no longer apply once another parameter is investigated and changed. Thus, the true or global optimum for all the parameters is elusive and may not be found except after a great deal of trial-and-error work with this approach. Multivariate optimization involves changing all the parameters of interest in concert and finding the best combination of all these parameters together to achieve the desired outcome. The time segmented numerical estimation approach is sufficiently fast and accurate to allow a multivariate optimization to be performed on models of HPLC separations. Therefore, it is a further object of this invention to provide a method that can predict and optimize two or more HPLC parameters simultaneously and in concert.

It is a further object of this invention to accurately predict retention times and peak widths of all peaks in a chromatogram, even when isocratic conditions are used initially in the course of the chromatogram, and thereafter a gradient is initiated, or the gradient rate is changed in the course of the gradient program. Because of inadequacies in the multivariate optimization procedures available (and not the approach in general), and the possibility of these procedures finding a local optimum rather than the desired global optimum, it is often more productive to optimize the successive sections of the chromatogram (following major changes in the gradient program) sequentially.

### BRIEF DESCRIPTION OF THE DRAWINGS

FIG. 1 is a schematic diagram of an analytical-scale HPLC system.

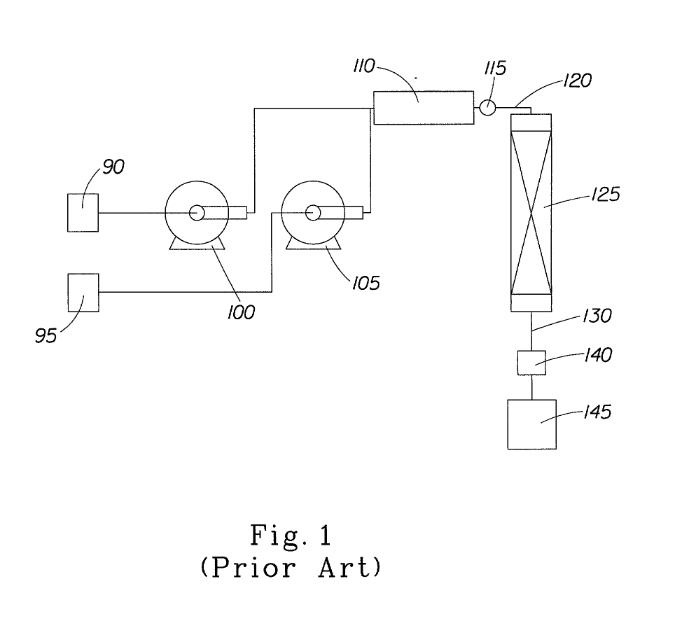

FIG. 2 is a flow diagram of the procedure to develop an HPLC protocol.

FIG. 3 is a flow diagram of the preferred method for modeling an HPLC system.

FIG. 4 is a flow diagram of the modified time segmented numerical estimation of peak width and retention time.

FIG. 5 is a flow diagram of the method for performing a multivariate optimization.

FIG. 6 is a computer structure that can be used to implement this invention.

### SUMMARY OF THE INVENTION

Peak compression is not negligible in gradient elution HPLC. The methods of this invention are more flexible and more accurate than other methods for modeling gradient elution HPLC separations because the methods of this invention account for peak compression caused by the spatial component of the mobile-phase gradient, in which the leading edge of the peak is exposed to weaker mobile phase than is the tailing edge of the same peak.

This invention relates to methods for modeling HPLC separations. This invention includes methods for modeling retention times and peak widths; predicting retention times, peak widths, and resolution; and performing a multivariate optimization of the separation over more than one user-adjustable parameter. The methods are applicable to isocratic and gradient separations and any combination of isocratic and gradient conditions.

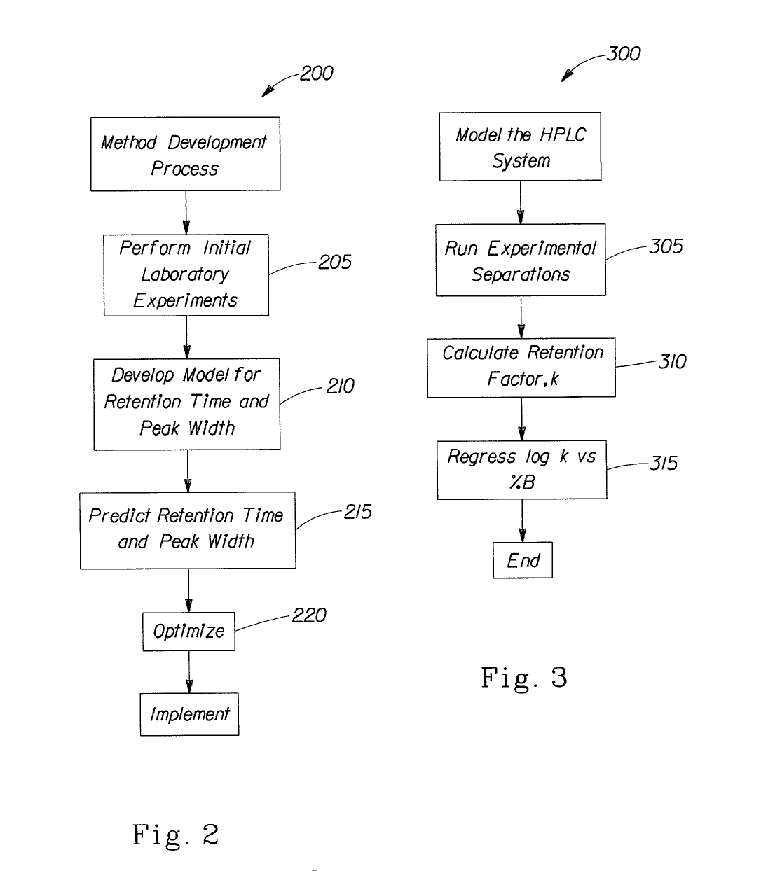

FIG. 2 represents an overall procedure to develop an HPLC protocol 200 using the methods of this invention. First, data from initial laboratory experiments are collected 205. The data are used to develop a relation (i.e., mathematical model) between retention and mobile phase strength 210, preferably by regression. The model predicts retention times and peak widths at values for mobile phase strength not necessarily included in the data 215. See R. D. Smith, E. G. Chapman, and B. W. Wright, “Pressure Programming in Supercritical Fluid Chromatography,” Analytical Chemistry 57: (14) pp. 2829-2836 (1985); L. R. Snyder, J. W. Dolan, and J. R. Grant, J. Chromatogr. 165 (1979) 3; and P. J. Schoenmakers, “Optimization of Chromatographic Selectivity, a Guide to Method Development,” J. Chromatography Library, 35 (1986). A multivariate optimization is performed on the adjustable parameters affecting retention time and peak width in the model 220. See H. Martens, and T. Naes, Multivariate Calibration, ISBN 0-471-90979-3, John Wiley & Sons, Ltd., Chichester (1989). The optimized conditions are then implemented. The optimized parameters can be implemented, for example, in an analytical scale or production scale HPLC system.

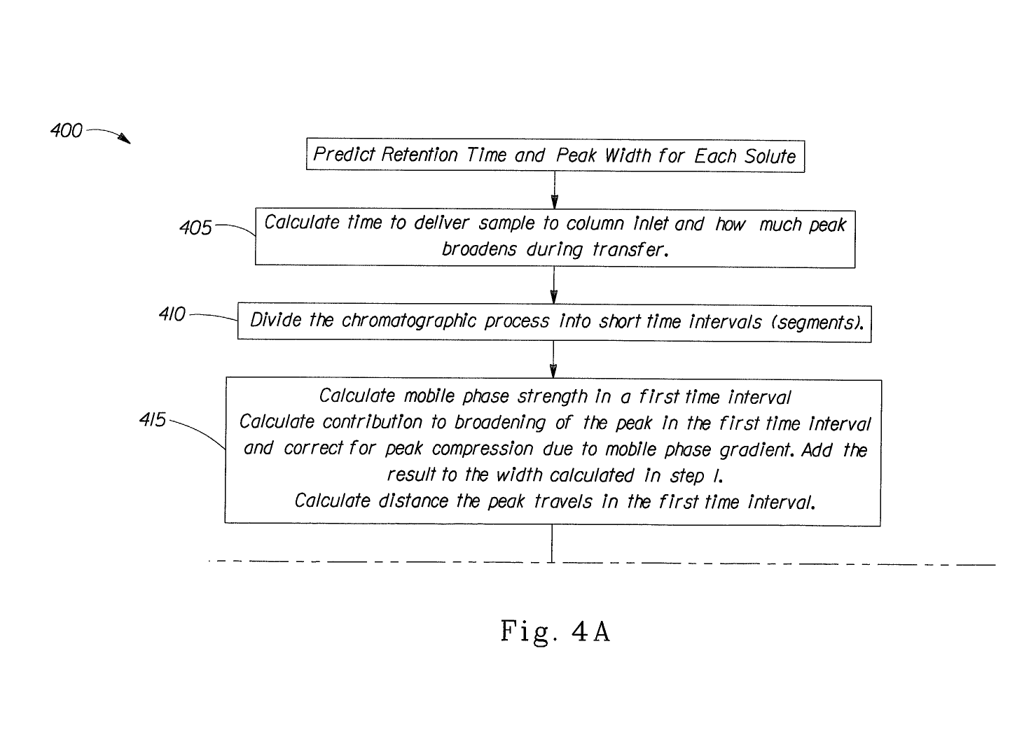

FIG. 3 represents a preferred method for modeling an HPLC system 300. First, isocratic experiments are performed 305. Retention factor, k, is calculated as described below using the data from the isocratic experiments 310. A relation between log k and one or more solvent parameters, such as volume percent of the strong component in the mobile phase (% B), is developed by regression 315 of the data.

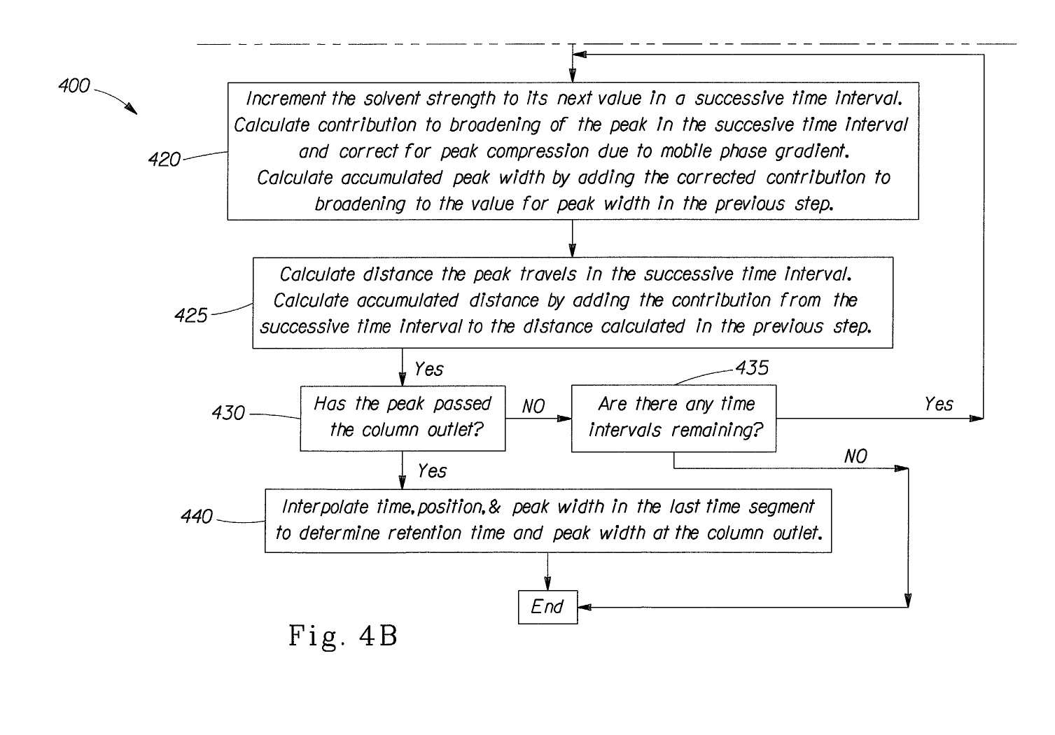

FIG. 4 represents a preferred method for predicting retention times and peak widths for solute peaks in a sample 400. First, the time to deliver the sample to the column inlet from the injector is calculated. The amount by which a solute peak broadens during this time is also calculated 405. See J. C. Giddings, Unified Separation Science, John Wiley & Sons, Inc. New York (1991). Time segmented numerical analyses then commence. The chromatographic process is divided into short time intervals called segments 410. In the first time segment, mobile phase strength, contribution to broadening of each solute peak, and distance the peak travels are calculated. The contribution to broadening is combined with the peak width calculated previously for the extra-column volume (i.e., between the injector where the sample is introduced into the system and the inlet of the HPLC column), and corrected for peak compression by a mobile phase gradient, if present, to give the accumulated peak width 415.

In the next successive time segment, the mobile phase strength is incremented to its next value and the mobile phase strength is calculated at the location of every peak. The contribution to broadening is calculated and combined with the corrected accumulated peak width 420. The distance the peak travels in this time segment is also calculated and added to the distance calculated previously to give the accumulated distance 425.

Next, a determination of whether the solute peak has passed the column outlet is made by comparing accumulated distance traveled to the column length 430. If the peak has not passed the column outlet, steps 420 to 430 are repeated until the peak elutes. If the peak has eluted, time, position, and peak width in the last time segment are interpolated to determine retention time and peak width at the column outlet 440. This process is repeated until all peaks have eluted or until the allowed total time is reached 435.

In a preferred embodiment of the invention, multivariate optimization is then performed on the model by searching through the allowed values of operational parameters that affect the model, and finding the combination of parameter values that produces the optimal separation. Multivariate optimization seeks the combination of parameter values producing the global optimum for a separation, that is, the best possible solution considering all the parameters in concert. Multivariate optimization must be distinguished from the univariate optimization approach (finding the apparent optimum for one parameter at a time).

Multivariate optimization may be executed using a variety of approaches, including full factorial analysis in which the parameters are searched systematically at regular intervals over the permissible ranges of all parameters. However, the preferred approach is carried out using a computerized spreadsheet tool such as Microsoft EXCEL® to perform the time segmented numerical estimation calculations of steps 4) and 5) and the EXCEL® SOLVER ADD-IN to find the optimal parameter values.

More specifically, this invention relates to the following embodiments. One embodiment of this invention relates to a method for predicting peak width of a solute peak in a gradient elution chromatography program. This method comprises:

i) performing a time segmented numerical analysis,

ii) calculating contribution to broadening of the solute peak in a given time segment;

iii) correcting accumulated peak width for peak compression occurring when the amount of strong component relative to weak component changes during the chromatography program;

iv) incrementing the amount of the strong component to its next value in a successive time segment;

v) repeating steps i-iv until the solute peak elutes; and

vi) optionally displaying the accumulated peak width of the solute peak. This method may further comprise vii) repeating steps i-vi) for at least one successive solute peak.

Another embodiment of this invention relates to a method for performing a multivariate optimization of a chromatographic separation, wherein the method comprises:

i) developing a relation between peak retention and effective solvent strength for each solute in a chromatogram,

ii) selecting a desired separation goal,

iii) identifying more than one chromatographic parameter, and

iv) searching through allowed values of the chromatographic parameters, and finding a combination of the values that produces the desired separation goal.

Another embodiment of this invention relates to a method for modeling, predicting, and optimizing gradient elution high performance liquid chromatography separations, wherein the method comprises the steps of:

1) describing physical dimensions of a high performance liquid chromatography system;

2) collecting data from at least two isocratic separations,

3) developing a relation between retention time expressed as log k and % B for the solute peak of interest in step 2),

4) predicting effects of parameter changes on the retention time of the solute peak of interest by a time segmented numerical analysis process,

5) predicting effects of parameter changes on peak widths of the solutes of interest using a modified time segmented numerical estimation approach,

6) determining the mobile phase pressure necessary at the column inlet to sustain flow rates investigated in steps 4) and 5) from pressure data collected in step 2), and

7) performing a multivariate optimization of user-adjustable chromatographic parameters.

Another embodiment of this invention relates to a method for predicting high performance liquid chromatography separations, wherein the method comprises the steps of:

1) inputting data comprising

I) physical dimensions of a high performance liquid chromatography system,

II) data from at least two isocratic separations,

2) transmitting the data input in step 1) to an internet web site, wherein the web site generates results using the data to model, predict, and optimize the separation, and

3) receiving the results generated in step 2). This method may further comprise 4) verifying the results by running a separation using the results received in step 3).

Another embodiment of this invention relates to a method for performing a multivariate optimization, wherein the method comprises:

1) developing a mathematical model of a process, wherein the mathematical model comprises a relation between at least two operational parameters,

2) identifying variables within the model that affect the relation,

3) selecting at least one desired end result,

4) searching through allowed values of the identified variables, and finding a combination of the values that produces the desired end result.

Another embodiment of this invention relates to articles of manufacture for carrying out the methods described above.

Another embodiment of this invention relates to a method for developing a high performance liquid chromatography protocol comprising the steps of:

1) collecting data from initial laboratory experiments,

2) developing a mathematical model to predict retention time and peak width of a solute peak, wherein the model relates retention to mobile phase strength,

3) predicting retention time and peak width using the model developed in step 2),

4) performing a multivariate optimization of user adjustable parameters affecting retention time and peak width, and

5) implementing the optimized parameters in a high performance liquid chromatography system.

### DETAILED DESCRIPTION OF THE INVENTION

### Definitions

Variables and Subscripts

% means volume percent, unless otherwise indicated.

A means the weak component in the mobile phase.

B means the strong component in the mobile phase.

H means plate height at a time and location in question.

k means retention factor, which is the ratio of the time a solute spends in the stationary phase to the time it spends in the mobile phase. Algebraically under isocratic conditions, k=(t_{R}−t_{M})/t_{M} when extra-column volume is insignificant. When extra-column volumes are considered, algebraically

k=(t_{R}−t_{M})/(t_{M}−tₑₓ).

k_{current segment} means retention factor of the current segment.

k_{previous segment} means retention factor of the segment immediately preceding the current segment.

L means length of the HPLC column.

Δl means distance a solute travels along the HPLC column during a given time segment.

n means the number of observations at each condition.

Peak Compression Correction Equation means:

$${σ}_{{total}^{current}} = {( {( {σ}_{{total}^{previous}} * ( 1 - \frac{\frac{1}{1 + {k}_{{segment}^{current}}} - \frac{1}{1 + {k}_{{segment}^{previous}}}}{1 - \frac{1}{1 + {k}_{{segment}^{previous}}}} ) )}^{2} + {σ}_{{segment}^{current}}^{2} )}^{1 / 2} .$$

Rs means resolution between two adjacent peaks and is calculated by

Rs=2(t_{R2}−t_{R1})/(W_{b1}+W_{b2}), wherein the subscripts 1 and 2 identify the peaks. σ means peak standard deviation expressed as distance.

σ_{current segment} means peak standard deviation expressed as distance arising in the current segment.

σ_{current total} means total peak standard deviation expressed as distance, including the current segment.

σ_{previous total} means total peak standard deviation expressed as distance, excluding the current segment.

Δt means time a solute travels during a given time segment.

t_{M} means the time for an unretained marker peak to reach the detector.

t_{R} means the time for a solute peak to reach the detector, i.e., the apparent retention time of a solute peak.

tₑₓ means the time required for the mobile phase to displace the extra-column volume in the chromatographic system at a specified flow rate.

u means the velocity of the mobile phase.

V means retention volume.

W_{b} means peak width in time units measured at the baseline by extrapolating from the inflection points to the baseline. For Gaussian peaks, W_{b}=4σ=(1+k)/u, where k is the local value at the column outlet.

Terms

“Hyperbaric chromatography” means a chromatography method carried out using a compressible solvating mobile phase at elevated pressure.

“Multivariate optimization” means changing two or more parameters of interest in concert and finding the best combination of all parameters together to achieve a desired outcome.

“Peak compression” means that, in a gradient elution chromatography program, the trailing edge of a solute peak travels at a slightly higher velocity relative to the mobile phase than the leading edge of the same peak in the absence of any other forces. This is because the trailing edge of the peak is exposed to a stronger mobile phase than the leading edge of the same peak in the presence of a gradient. Practically speaking, however, peaks widen due to eddy diffusion and other known forces as they travel through the column. The contribution to widening often outweighs the contribution of peak compression due to the mobile phase gradient; thus, a peak usually widens as it moves through the column. However, such a peak widens less in a gradient elution chromatography program than it would in the absence of the gradient because of peak compression.

“Solvating gas chromatography” means a hyperbaric chromatography method where the pressure at the column outlet is at or near ambient pressure.

### Methods of the Invention

This invention relates to methods for modeling HPLC parameters, predicting HPLC separations, and optimizing the parameters involved in HPLC separations. The method comprises the following steps.

Step 1) is optional. However, the accuracy of the retention time predictions in step 4) will be improved when the physical dimensions of the HPLC system, particularly the extra-column volumes and the dwell volume are described. One skilled in the art would be able to calculate extra-column volumes and dwell volumes by conventional methods without undue experimentation. For example, see L. R. Snider, J. J. Kirkland, and J. L. Glajch, Practical HPLC Method Development, 2^{nd} ed., Wiley, p. 392 (1997).

Step 2) comprises collecting data comprising retention times for an unretained marker and for all the solutes of interest (i.e., at least one solute) as a function of the composition of the mobile phase (expressed as the volumetric % B) for a series of chromatograms at various % B values. In addition, pressure data are optionally collected during these experiments.

In a preferred embodiment of the invention, step 2) is carried out by collecting data from two or more isocratic separations at different % B values. In an alternative embodiment of the invention, step 2) is carried out by collecting data from two or more gradient elution separations. The gradients must be linear, and the separations must be run at two or more different gradient rates.

In step 3), a relation between solute peak retention and effective solvent strength is developed for each solute. Any relation between solute peak retention and effective solvent strength may be used in the multivariate optimization in step 7). For example, solute peak retention can be measured by retention time, k, log k, retention volume (V), and others. The variable k is the retention factor for a given solute in a given chromatogram in step 2), and is defined as the time the solute spends in the stationary phase divided by the time it spends in the mobile phase. Effective solvent strength can be influenced by parameters such as pH, temperature, ionic strength, and composition (e.g., % B), with % B being preferred. The % B is the volumetric percentage of the strong component in the mobile phase. Log k versus % B is preferred because it is a relation that is nearly linear. In a more preferred embodiment of the invention, a relation between log k and % B is developed for each solute.

Step 3) is preferably carried out using a quadratic regression over at least four data points. Alternatively, an exact quadratic relation can be calculated from three data points, a linear relation can be regressed from three or more data points, or an exact linear fit can be calculated from two data points. This regression is performed using data collected in step 2), from two or more isocratic separations at different % B values.

In an alternative embodiment of the invention, known methods can be used to estimate isocratic k values from experiments performed using linear mobile phase gradients in step 2). See P. J. Schoenmakers, “Optimization of Chromatographic Selectivity, A Guide to Method Development,” Journal of Chromatography Library, vol. 35, Elsevier Science Publishers, B. V., Amsterdam, pp. 192-199 (1972). These estimates can then be used in the regression to derive a relation between log k and % B. Similarly, any other parameter affecting k values for some or all of the solutes may be regressed and used in place of or in addition to % B as described in the following steps.

In a preferred embodiment of the invention, the relation between log k and % B is developed by regression using data from isocratic experiments. However, any relation between log k and % B developed in step 3) can be used to perform the multivariate optimization in step 7).

In step 4) the effects of parameter changes on the solute retention times are predicted using the time segmented numerical estimation approach. Step 4) is carried out for each solute peak using a relation between log k and % B developed in step 3). Preferably, the time required for solute transport through the extra-column volume between the injector and the column inlet is calculated using the physical dimensions of the system described in step 1). Solute retention times on the column are predicted by using the regression coefficients of step 3) to estimate k values for the solutes as a function of % B at % B values not necessarily included in the data collected in step 2), then applying from chromatographic theory the expected effects of the influence of other parameters such as column length and diameter, column porosity, and mobile phase flow rate. Since during gradient programming % B changes both as a function of time and specific location on the column, the applicable % B value and the local k value are calculated individually for each solute at each time segment. Thus, the distance each solute travels along the column during a given time segment is

$$Δ l = \frac{u}{1 + k} Δ t .$$

This is applicable to any gradient, whether continuous or discontinuous, and including isocratic conditions (which result when the gradient rate is set to zero throughout the chromatogram) as long as the appropriate % B is determined for the time segment and location of the peak in question and the corresponding k value is used. The total distance the peak has traveled at the end of the current time segment is compared with the total column length to determine if the peak has eluted. If not, the process is repeated in subsequent time segments until the peak is determined to have eluted. The last-used time segment is then interpolated to estimate the actual elution time of the peak from the column. The sum of this column transit time and the time for the mobile phase to displace the extra-column volume, tₑₓ, gives the apparent retention time, t_{R}, for the solute.

If % B is constant throughout the entire travel of a peak through the column, its retention time may be alternatively calculated in a single step without segmenting time:

t_{R}=(L×(1+k))/u+tₑₓ=t_{M}×(1+k)+tₑₓ.

In step 5) the effects of parameter changes on the resulting solute peak widths are predicted using a modified time segmented numerical estimation approach. Step 5) may be done concurrently with step 4). Preferably, the extent of peak broadening caused by the transport through the extra-column volume between the injector and the column inlet is calculated using the methods of Atwood and Golay, see J. Chromatogr., 218, pp. 97-122 (1981).

Once the solutes reach the column inlet the time segmented numerical estimation is commenced. The value of % B is taken as constant for a given peak during each time segment, and is incremented to its next value (according to time and location for each peak) in each successive time segment. The contribution to broadening of the peak during a given time segment is easily calculated from known theory, briefly Δσ=\sqrt{HΔl} where Δσ is the contribution to the (spatial) standard deviation of the peak during the time segment in question, H is the plate height for the peak at the time and location in question, and Δl is the distance the solute travels along the column during the time segment. H is estimated from any applicable equation with appropriate variables (such as mobile-phase velocity, particle size, and diffusion coefficient) for the specific chromatographic conditions in use. For suitable equations, see J. J. van Deemter, F. J. Zuiderweg, and Klinkenberg, Chem. Eng. Sci., 5, 271 (1956); C. Horvath, and H. J. Lin, J. Chromatogr. Sci., 149, 43 (1978); and G. J. Kennedy, and J. H. Knox, J. Chromatogr. Sci. 10, 149 (1972). If % B is constant during the course of the chromatogram, the broadening from each time segment may be combined (as the square root of the sum of the squares) to estimate the width of a peak at the its current location. However, if % B changes during the course of the chromatogram, the accumulated width of the peak prior to the current time segment must be corrected before being combined with the contribution from the current time segment using the Peak Compression Correction Equation or one of its equivalents. The Peak Compression Correction Equation is:

$${σ}_{{total}^{current}} = {( {( {σ}_{{total}^{previous}} * ( 1 - \frac{\frac{1}{1 + {k}_{{segment}^{current}}} - \frac{1}{1 + {k}_{{segment}^{previous}}}}{1 - \frac{1}{1 + {k}_{{segment}^{previous}}}} ) )}^{2} + {σ}_{{segment}^{current}}^{2} )}^{1 / 2} .$$

In the Peak Compression Correction Equation, a means standard deviation expressed as distance and k means retention factor. Equivalents of the Peak Compression Correction Equation are used in alternative embodiments of this invention. For example, in one alternative embodiment of this invention, any algebraic equivalent to the Peak Compression Correction Equation may be used, or any other equation which can be transformed, using known algebraic identities, into an algebraic equivalent to the Peak Compression Correction Equation. In another alternative embodiment of the invention, the Peak Compression Correction Equation can be derived in terms of standard deviation expressed as time or standard deviation expressed as volume. One skilled in the art would be able to derive the equivalents to the Peak Compression Correction Equation in each of the embodiments of this invention without undue experimentation.

This correction for estimating the peak width in the time segmented numerical estimation approach is applicable to any gradient shape since all that is required to correct the previous total peak width is knowledge of the k values in the current and the immediately preceding time segment. Note also that this equation reduces to the square root of the sum of the squares when k is constant (meaning % B is constant), in agreement with the appropriate practice when % B is constant as described earlier.

In step 6) the mobile phase pressure necessary at the column inlet to sustain the flow rates investigated in the course of steps 4) and 5) is determined from the pressures observed in step 2) using the proportionalities in Darcy's law. See B. F. Karger, L. R. Snyder, and C. Horvath, An Introduction to Separation Science, John Wiley & Sons, New York, p. 90 (1973).

In step 7) the optimal values of the user-adjustable chromatographic parameters to achieve the desired separation goals are determined by a multivariate optimization. Step 7) comprises selecting a desired separation goal, identifying the user-adjustable chromatographic parameters to be varied, searching through the allowed values of the parameters, and finding the combination of parameter values that produces the desired separation goal. The desired separation goal may be selected by setting it as a default (e.g., in software for carrying out the multivariate optimization), or it may be defined by the user. For example, the desired separation goal can be minimizing the analysis time, or the solvent usage, or the cost of the analysis (which would be a function of solvent usage, time, and other conditions) while achieving or exceeding the other separation goal or goals. Alternatively, the desired separation goal may be maximizing detectability of the solutes, maximizing resolution within a given analysis time or within a given solvent usage limit, or maximizing the production rate of a solute at the column outlet at a stated level of purity from other sample components, or minimizing the production cost. The chromatographic parameters to be varied may be identified by setting them as a default or they may be defined by the user.

Multivariate optimization seeks the combination of parameter values producing the global optimum for a separation, that is, the best possible solution considering all the parameters in concert. Multivariate optimization must be distinguished from the univariate optimization approach (finding the apparent optimum for one parameter at a time). Multivariate optimization can be carried out on one or more, preferably two or more, more preferably three or more parameters simultaneously. Furthermore, the multivariate optimization of this invention can be carried out varying chromatographic parameters selected by the user.

Multivariate optimization may be executed using a variety of approaches, including full factorial analysis in which the parameters are searched systematically at regular intervals over the permissible ranges of all parameters. However, the preferred approach is carried out using Microsoft EXCEL® to perform the time segmented numerical estimation calculations of steps 4) and 5) and the EXCEL® SOLVER ADD-IN to find the optimal parameter values. (SOLVER is faster than full factorial analysis but may sometimes return parameter values corresponding to a local optimum instead of the desired global optimum. Therefore, when using SOLVER, it is desirable to repeat the optimization process from several different starting points or to perform a coarse factorial analysis first using the prediction capabilities described in steps 4) and 5) to find the regions of the factor space to explore in more detail. See E. Joseph Billo, Excel for Chemists: A Comprehensive Guide, John & Sons, Incorporated, Jan. 1997; and P. Blattner, and L. Ulrich, Special Edition Using Microsoft Excel 2000, Que, Dec. 1998.) Typically, the minimum time required to separate the modeled peaks at a specified minimum acceptable resolution is sought. Constraints are imposed to avoid impractical solutions (e.g., inlet pressures and flow rates cannot be beyond the maximum of which the equipment is capable, mobile phase modifier concentrations (% B) must be 0 to 100%, column dimensions are limited to practical values). Since the calculations previously described provide estimates of the retention times and peak widths, resolution can easily be calculated by known methods as a function of the user-adjustable parameters. The separation goals can be specified in terms of resolution between the peaks of interest and the nearby peaks. For isocratic chromatograms, the usual parameters varied are the column length, stationary-phase particle size, mobile-phase flow rate, and % B, but any other parameter included in the model may be varied if desired. For gradient-elution chromatograms additional parameters such as an initial hold time, dwell volume of the chromatographic equipment, program rate or rates, etc., are required to describe the gradient shape. See L. R. Snyder, J. J. Kirkland, and J. L. Glajch, Practical HPLC Method Development, 2^{nd} ed., Wiley, p. 392 (1997).

Although the methods described above have been specifically described with HPLC, the effects of peak compression will impact other chromatographic separation methods involving gradient elution. Therefore, the Peak Compression Correction Equation can also be applied to other chromatographic separation methods involving gradients, provided that the separation method employs a solvating mobile phase. For example, the Peak Compression Correction Equation can be applied to unified chromatography methods, high temperature high performance liquid chromatography, subcritical fluid chromatography, and supercritical fluid chromatography. The Peak Compression Correction Equation can also be applied to hyperbaric chromatography (e.g., solvating gas chromatography) methods; however, additional corrections will be necessary as compressibility of the fluid mobile phase increases.

Furthermore, the multivariate optimization described above can also be applied to virtually any chromatographic separation method. Examples of chromatographic separations to which multivariate optimization can be applied include all of those discussed above and thin layer chromatography, gel permeation chromatography, ion exchange chromatography, and ion chromatography.

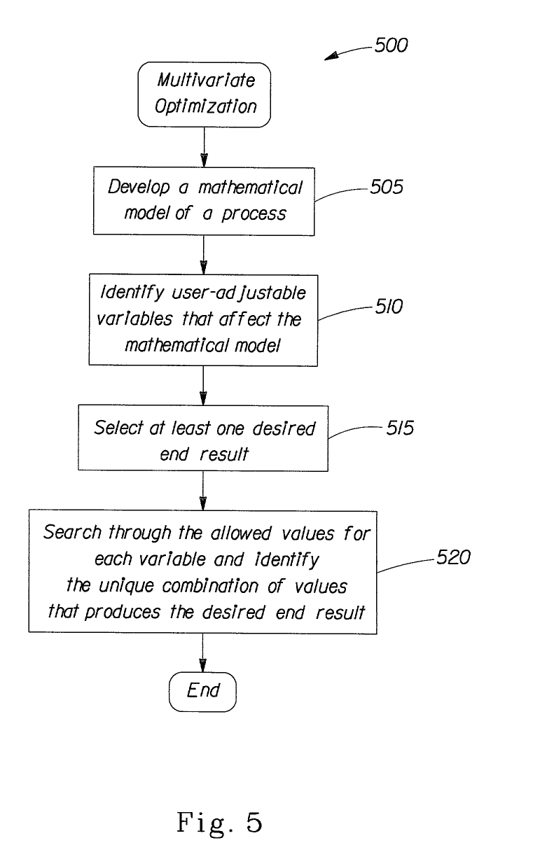

The methods for multivariate optimization disclosed in this invention are also applicable to production scale or analytical scale processes (in addition to the above chromatography methods) that are capable of being mathematically modeled and that have more than one operational parameter. FIG. 5 represents the generally applicable method for multivariate optimization 500. The method comprises:

1) developing a mathematical model of a process 505, wherein the mathematical model comprises a relation between at least two operational parameters,

2) identifying variables within the model that affect the relation 510,

3) selecting at least one desired end result 515,

4) searching through allowed values for the identified variables, and finding a combination of the values that produces the desired end result 520.

Examples of processes that can be optimized according to the generally applicable method include: gas chromatography, distillation, reactive distillation, batch reactions, semi-batch reactions, combinations thereof, and others.

### Articles of Manufacture: Program Products

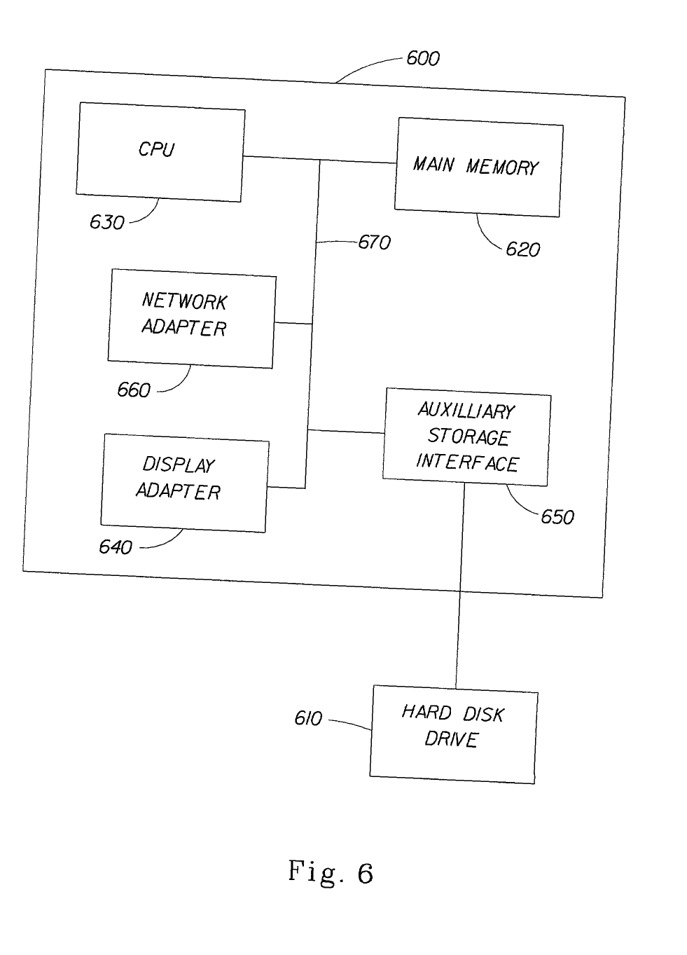

This invention can be implemented, for example, by operating a computer system to execute a sequence of machine readable instructions for performing the method steps in the methods described above. FIG. 6 represents a computer system 600. The computer system 600 comprises the following system components: main or central processing unit (“CPU”) 630 connected to main memory 620 (e.g., random access memory (“RAM”)), a display adapter 640, an auxiliary storage interface 650, and a network adapter 660. These system components are interconnected through the use of a system bus 670.

CPU 630 can be, for example, a PENTIUM® processor made by Intel Corporation of Santa Clara, Calif. However, this invention is not limited to any one make of processor, and may be practiced using another type of processor such as a coprocessor or an auxiliary processor. Auxiliary storage adapter 650 is used to connect mass storage devices (such as hard disk drive 610) to computer system 600. The program need not necessarily all simultaneously reside on computer system 600. Indeed, this would likely be the case if computer system 600 were a network computer, and therefore, be dependent upon an on-demand shipping mechanism for access to mechanisms or portions of mechanisms that reside on a server. Display adapter 650 is used to directly connect a display device (not shown) to the computer system 600. Network adapter 660 is used to connect the computer system 600 to other computer systems.

The machine readable instructions may reside in various types of signal bearing media, such as the hard disk drive 610 and main memory 620. This invention relates to a program product comprising signal bearing media embodying a program of machine readable instructions, executable by a data processor such CPU 630, to perform method steps. The machine readable instructions may comprise any one of a number of known programming languages, such as C, C++, and others.

This invention may be implemented on any type of computer system and is not limited to the type of computer system shown in FIG. 6. While this invention has been described in the context of a fully functional computer system, one skilled in the art will appreciate that the mechanisms of this invention are capable of being distributed as a program product in a variety of forms, and that this invention applies equally regardless of the particular type of signal bearing media used to carry out the distribution.

This invention further relates to articles of manufacture for performing the methods described above. The articles are program products comprising signal bearing media embodying a program of machine readable instructions executable by a data processor for performing the method steps in the above methods. The signal bearing media can be, for example, transmission-type media such as digital and analog communications links and wireless; recordable media such as floppy disks and CD-ROMs (i.e., read-only memories); or web sites on the internet.

In a preferred embodiment of the invention, the computer useable media is a web site on the internet and the computer readable program code means is software stored in the web site. A user can (e.g., for a fee) use a personal computer to access the web site via a web page, and input data. The software then performs one or more of the above methods on the user's data and sends the results of the analysis back to the user's personal computer.

In an alternative embodiment of the invention, the software in the web site may be downloadable to the user's personal computer from the internet, so that the consumer can then input data and run the methods on the personal computer.

### Methods of Use

This invention further relates to methods of using the above methods to develop HPLC protocols. The method for developing a HPLC protocol comprises the steps of:

1) collecting data from initial laboratory experiments,

2) developing a mathematical model to predict retention time and peak width of a solute peak, wherein the model relates retention to mobile phase strength,

3) predicting retention time and peak width using the model developed in step 2),

4) performing a multivariate optimization of user adjustable parameters affecting retention time and peak width, and

5) implementing the optimized parameters in a high performance liquid chromatography system.

This invention further relates to methods for using the articles of manufacture for developing HPLC protocols. The method comprises the steps of:

1) inputting data comprising

I) physical dimensions of a high performance liquid chromatography system;

II) data from at least two isocratic separations, wherein the data comprise

a) retention time for an unretained marker as a function of mobile phase composition expressed as % B,

b) retention time for at least one solute peak of interest as a function of mobile phase composition expressed as % B, and

c) mobile phase pressure, wherein the isocratic separations are carried out at different % B values;

2) transmitting the data input instep 1) to an internet web site, wherein the web site generates results using the data to model, predict, and optimize the separation by a process comprising

I) developing a relation between retention time expressed as log k and % B for the solute peak of interest in step 1), wherein the relation is developed by regression of the data input in step 1);

II) predicting effects of parameter changes on the retention time of the solute peak of interest by a time segmented numerical analysis process comprising

i) performing a time segmented numerical analysis, wherein, within a given time segment, a strong component is presumed present in an amount that is constant;

ii) calculating distance the solute peak travels along the column during the given time segment and adding the distance to total distance the solute peak traveled along the column;

iii) incrementing the amount of the strong component to its next value in a successive time segment; and

iv) repeating steps i-iii) until the solute peak elutes;

III) predicting effects of parameter changes on peak widths of the solutes of interest using a modified time segmented numerical estimation approach comprising

i) performing a time segmented numerical analysis, wherein, within a given time segment, a strong component is presumed present in an amount that is constant;

ii) calculating contribution to broadening of the solute peak in the given time segment;

iii) correcting accumulated peak width for peak compression occurring when the amount of strong component relative to weak component changes during the chromatography program;

iv) incrementing the amount of the strong component to its next value in a successive time segment; and

v) repeating steps i-iv) until the solute peak elutes;

IV) determining the mobile phase pressure necessary at column inlet to sustain flow rates investigated in steps 4) and 5) from the pressure data collected in step 2); and

V) performing a multivariate optimization of user-adjustable chromatographic parameters, wherein multivariate optimization is carried out by a method comprising

i) selecting a desired separation goal,

ii) identifying the chromatographic parameters,

iii) searching through allowed values of the chromatographic parameters, and finding a combination of the values that produces the desired separation goal; and

3) receiving the results generated in step 2).

The results obtained in step 3) can be verified by: 4) verifying the results by running a separation using the results received in step 3).

### EXAMPLES

These examples are intended to illustrate the invention to those skilled in the art and should not be interpreted as limiting the scope of the invention set forth in the claims.

All work is performed on a Waters® Alliance Model 2690 HPLC system. The column is a Waters® Symmetry C-18, which has dimensions 4.6 mm×150 mm with 5 micrometer diameter packing. The temperature is 27° C. The detector is a Waters 996 Photodiode Array Detector that is monitored at 210 and 254 nanometers.

### Example 1

The mobile phase components are water obtained from a Millipore, Inc. Milli-Q® Plus purification system (weak solvent A) and methanol (strong solvent B). No additives are used. The test solutes are methyl paraben and ethyl paraben. Each is dissolved at a concentration of 50 micrograms per milliliter in a volumetric mixture of 80/20 water/methanol. The extra-column volumes of the HPLC system are determined by measuring the appropriate dimensions, the dwell volume is determined using the method of Snyder et al. in Practical HPLC Method Development, 2^{nd} ed., John Wiley & Sons, Inc., New York, Ch. 10, pp. 392-394 (1997). Nineteen isocratic separations are performed at a flow rate of 1.00 mL/min. The average retention time for each solute at a given % B and the standard deviation are calculated from the data and are shown in Table 1.

TABLE 1
Accuracy of the Method

| | | Test Solutes: | | | |
|---|---|---|---|---|---|
| % B | η | Methyl Paraben | | | |
| in the | (number of | | standard | Ethyl Paraben | |
| mobile | runs at a | t_{Rm}, | deviation | t_{Re}, | standard |
| phase | given % B) | min. | of t_{Rm} | min. | deviation of t_{Re} |
| 40 | 3 | 7.530 | 0.009 | 15.284 | 0.033 |
| 50 | 5 | 4.172 | 0.006 | 6.878 | 0.010 |
| 60 | 3 | 2.778 | 0.0010 | 3.798 | 0.0017 |
| 70 | 5 | 2.167 | 0.0007 | 2.588 | 0.0011 |
| 80 | 3 | 1.868 | 0.006 | 2.055 | 0.006 |

The value of t_{M} is determined using ammonium nitrate as the unretained marker. From these data, log k values are determined and regressed against % B and (% B)² using the form log k=a+b(% B)+c(% B)² to determine the coefficients a, b, and c for each solute. The accuracy of this equation at predicting log k values (and retention times) is then assessed by predicting the retention times of methyl and ethyl paraben using % B values of 45, 55, and 65% and comparing these predictions with experimental trials. The root-mean-square error in predicting t_{R} at 45, 55, and 65% methanol in the mobile phase is 0.007 min for both solutes.

The peak widths are predicted using a value of the solute diffusion coefficient of 4.55 ×10⁻⁶ cm²/s and compared with the average peak widths observed at each % B in Table 1. The largest deviation between prediction and the observed average widths is 0.015 min (or 0.9 s). This amounts to 10% of the width of the particular peak in question.

### Example 2

The data and model from Reference Example 1 are used to predict retention times and peak widths for methyl paraben and ethyl paraben run under gradient conditions at four different gradient rates. The starting conditions are 30% methanol pumped at 1.5 mL/min with gradients of 2.5, 5, 10, and 20%/min applied starting at the time of the injection. Three HPLC experiments are conducted at each gradient rate, the retention times of each triplicate set are averaged, and these results compared with the predictions. The largest deviation between the predicted and observed retention time averages is 0.03 min (or 2 s).

The peak widths are also predicted using a value of the solute diffusion coefficient of 4.55×10⁻⁶ cm²/s and are compared with the experimental observations. The largest time deviation in the predicted and observed widths is 0.01 minutes (or 0.6 s) which amounts to 0.3% of the observed width of the subject peak. The largest relative deviation is 7%.

### Example 3

Water is used as the A mobile phase component and methanol as the B mobile phase component. The flow rate is 1 mL/min. The observed hold-up time for the system is 1.743 min. The contribution to the observed hold-up time caused by the extra-column volume is determined from the dimensions of the system components and the flow rate to be 0.074 min. The following data, presented below in Table 2, are collected isocratically.

TABLE 2
Retention Times Measured at Various % B Values in Isocratic Separations
retention times (minutes)

| | | | | | | Benzoic | Methyl | Ethyl |
|---|---|---|---|---|---|---|---|---|
| % B | BenzylOH | Phenol | PhenoxETOH | Unknown | K Sorbate | Acid | Paraben | Paraben |
| 10 | 6.273 | 6.785 | 10.352 | 12.668 | 13.698 | 16.290 | 38.629 | 95.079 |
| 20 | 4.864 | 5.354 | 6.861 | 7.737 | 8.737 | 10.267 | 18.677 | 38.316 |
| 30 | 3.852 | 4.221 | 4.852 | 4.919 | 5.822 | 6.646 | 9.756 | 16.405 |
| 40 | 3.070 | 3.294 | 3.541 | 3.541 | 3.952 | 4.340 | 5.392 | 7.613 |
| 50 | 2.529 | 2.647 | 2.729 | 2.751 | 2.887 | 3.058 | 3.414 | 4.167 |

None of these conditions resolve all the peaks with a resolution of 2.0 or greater, although the lowest resolution observed for the 20% B trial is 1.9 between the BenzylOH and the Phenol peaks. From these data, log k values are determined and regressed against % B and (% B)² using the form log k=a+b(% B)+c(% B)² obtaining the coefficients in Table 3.

TABLE 3
Regression Coefficients

| | | | | | | Benzoic | Methyl | Ethyl |
|---|---|---|---|---|---|---|---|---|
| | BenzylOH | Phenol | PhenoxETOH | Unknown | K Sorbate | Acid | Paraben | Paraben |
| c | −1.16E-04 | −1.57E-04 | −6.52E-05 | 3.39E-05 | −9.86E-05 | −1.16E-04 | −1.36E-05 | 3.20E-05 |
| b | −0.012 | −0.009 | −0.019 | −0.028 | −0.019 | −0.019 | −0.033 | −0.042 |
| a | 0.562 | 0.586 | 0.910 | 1.094 | 1.057 | 1.141 | 1.671 | 2.160 |

A time segmented numerical estimation is undertaken using Microsoft EXCEL® to determine the effects of parameter changes on the resulting chromatogram. The best combination of column length, flow rate, and % B is then determined using the SOLVER function in Microsoft EXCEL® to optimize isocratic conditions for eluting the Benzoic Acid peak in minimum time. Resolution for all peaks is required to be at least 2.0, and the flow rate is constrained to a maximum of 2 mL/min. The following conditions are determined to be optimal (that is, meeting all the constraints and producing the shortest retention time for the last peak of interest): column length, 22.19 cm; flow rate, 2.00 mL/min; and % B, 20.29. These conditions predict the optimized results in Table 4.

TABLE 4
Optimized Retention Times, Peak Widths, and Resolution

| | | | | | | Benzoic | Methyl | Ethyl |
|---|---|---|---|---|---|---|---|---|
| | BenzylOH | Phenol | PhenoxETOH | Unknown | K Sorbate | Acid | Paraben | Paraben |
| t_{R} (min) | 3.58 | 3.94 | 5.07 | 5.56 | 6.44 | 7.55 | 13.66 | 27.65 |
| w_{b} (min) | 0.18 | 0.19 | 0.24 | 0.26 | 0.30 | 0.34 | 0.61 | 1.23 |
| Rs | 8.94 | 2.00 | 5.37 | 2.00 | 3.20 | 3.51 | 12.89 | 15.24 |
| (against | | | | | | | | |
| preceding | | | | | | | | |
| peak) | | | | | | | | |

(Rs for the first peak, BenzylOH, is calculated against a non-retained peak not shown in the table.) The optimization is then recalculated, as before, except that the column length is fixed at 20 cm, the closest common column length to the optimal length. The following conditions are determined to be optimal for the 20-cm column length: flow rate, 1.61 mL/min; and % B, 20.33. These conditions predict the results in Table 5.

TABLE 5
Predicted Retention Times, Peak Widths, and Resolution Using a 20 cm HPLC
Column

| | | | | | | Benzoic | Methyl | Ethyl |
|---|---|---|---|---|---|---|---|---|
| | BenzylOH | Phenol | PhenoxETOH | Unknown | K Sorbate | Acid | Paraben | Paraben |
| t_{R} (min) | 4.01 | 4.41 | 5.67 | 6.21 | 7.19 | 8.43 | 15.24 | 30.82 |
| w_{b} (min) | 0.20 | 0.22 | 0.27 | 0.29 | 0.33 | 0.38 | 0.68 | 1.36 |
| Rs | 8.93 | 2.00 | 5.37 | 2.00 | 3.21 | 3.52 | 12.95 | 15.33 |
| (against | | | | | | | | |
| preceding | | | | | | | | |
| peak) | | | | | | | | |

The possibility of using a % B gradient to shorten the retention of Methyl Paraben and Ethyl Paraben is investigated by entering the appropriate parameters in the model to describe the % B gradient. It is found that a step change in % B from 20.33% to 55%, programmed to occur 7 minutes after injection, will work effectively. This step, after the gradient delay due to the dwell volume and the hold-up time of the column, will reach the column outlet 8.94 minutes after injection, that is, just after the Benzoic Acid peak has eluted. This step in the value of % B causes the remaining peaks to elute earlier than with the isocratic conditions, thus shortening overall analysis time. The results in Table 6 meet all the resolution requirements and predict a total analysis time of approximately 10 minutes.

TABLE 6
Retention Times, Peak Widths, and Resolution in a Gradient Elution Program

| | | | | | | Benzoic | Methyl | Ethyl |
|---|---|---|---|---|---|---|---|---|
| | BenzylOH | Phenol | PhenoxETOH | Unknown | K Sorbate | Acid | Paraben | Paraben |
| t_{R} (min) | 4.01 | 4.41 | 5.67 | 6.21 | 7.19 | 8.43 | 9.48 | 10.02 |
| w_{b} (min) | 0.20 | 0.22 | 0.27 | 0.29 | 0.33 | 0.38 | 0.09 | 0.12 |
| Rs | 8.93 | 2.00 | 5.37 | 2.00 | 3.21 | 3.52 | 4.63 | 5.95 |
| (against | | | | | | | | |
| preceding | | | | | | | | |
| peak) | | | | | | | | |

### Effects of the Invention

As would be clear to one skilled in the art, this invention dramatically reduces the time and resources needed to develop and optimize HPLC protocols. An HPLC separation can be modeled and optimized using data from as few as 2 to 4 laboratory experiments. A globally optimized HPLC protocol can be developed in a few hours.

What is claimed is:

1. A method for predicting peak width of a solute peak in a gradient elution chromatography program, wherein the method comprises:
i) performing a time segmented numerical analysis, wherein, within a given time segment, a strong component is presumed present in an amount that is constant;
ii) calculating contribution to broadening of the solute peak in the given time segment;
iii) correcting accumulated peak width for peak compression occurring when the amount of strong component relative to weak component changes during the chromatography program;
iv) incrementing the amount of the strong component to its next value in a successive time segment;
v) repeating steps i-iv until the solute peak elutes; and
vi) optionally displaying the accumulated peak width of the solute peak.

2. The method of claim 1, further comprising:
vii) repeating steps i-vi) for at least one successive solute peak.

3. The method of claim 1 or 2, wherein accumulated peak width at the given time segment is calculated according to an equation selected from the group consisting of:
$${σ}_{{total}^{current}} = {( {( {σ}_{{total}^{previous}} * ( 1 - \frac{\frac{1}{1 + {k}_{{segment}^{current}}} - \frac{1}{1 + {k}_{{segment}^{previous}}}}{1 - \frac{1}{1 + {k}_{{segment}^{previous}}}} ) )}^{2} + {σ}_{{segment}^{current}}^{2} )}^{1 / 2} ,$$
wherein k represents retention factor, and σ represents peak standard deviation expressed as distance; algebraic equivalents thereof; an equation which can be transformed, using known identities from chromatographic theory, into an algebraic equivalent thereof; and derivations thereof wherein peak standard deviation is expressed as time or as volume.

4. The method of claim 1, wherein the gradient is selected from the group consisting of linear gradients, non-linear gradients of any shape, step-wise changes in mobile phase compositions, combinations thereof, and combinations of isocratic conditions with one or more of said gradients.

5. The method of claim 1, wherein the chromatography program is selected from the group consisting of a high performance liquid chromatography program, a unified chromatography program, a high temperature high performance liquid chromatography program, a subcritical fluid chromatography program, a supercritical fluid chromatography program, and a hyperbaric chromatography program.

6. The method of claim 1, wherein step iii) further comprises calculating distance the solute peak travels during the given time segment and adding the distance to total distance the solute peak traveled.

7. The method of claim 6, further comprising the steps of:
vii) interpolating in the last time segment to estimate retention time of the solute peak.

8. The method of claim 7, further comprising:
viii) repeating steps i-vii) for at least one successive solute peak.

9. The method of any one of claims 1, 2, 3, 4, 5, 6, 7, and 8, wherein accumulated peak width at the given time segment is calculated according to an equation selected from the group consisting of:
$${σ}_{{total}^{current}} = {( {( {σ}_{{total}^{previous}} * ( 1 - \frac{\frac{1}{1 + {k}_{{segment}^{current}}} - \frac{1}{1 + {k}_{{segment}^{previous}}}}{1 - \frac{1}{1 + {k}_{{segment}^{previous}}}} ) )}^{2} + {σ}_{{segment}^{current}}^{2} )}^{1 / 2} ,$$
wherein k represents retention factor, and σ represents peak standard deviation expressed as distance: algebraic equivalents thereof; an equation which can be transformed, using known identities from chromatographic theory, into an algebraic equivalent thereof; and derivations thereof wherein peak standard deviation is expressed as time or as volume.

10. A method for performing a multivariate optimization of a chromatographic separation, wherein the method comprises:
i) developing a relation between peak retention and effective solvent strength for each solute in a chromatogram,
ii) selecting a desired separation goal,
iii) identifying more than one chromatographic parameter, and
iv) searching through allowed values of the chromatographic parameters, and finding a combination of the values that produces the desired separation goal.

11. The method of claim 10, wherein step i) is carried out by developing a relation between log k and % B for each solute in a chromatogram, wherein k represents retention factor and % B represents volume percentage of a strong component.

12. The method of claim 11, wherein step i) is carried out by collecting data from two or more isocratic separations at different % B values, wherein the data comprise retention time for an unretained marker peak and retention time for at least one solute of interest, as a function of mobile phase composition; and thereafter regressing log k versus % B.

13. The method of claim 11, wherein step i) is carried out by collecting data from two or more gradient elution separations, wherein the separations are run at two or more different gradient rates, and wherein the gradient rates are linear, and thereafter estimating isocratic k values to derive the relation between log k and % B.

14. The method of claim 10, wherein step i) is carried out by regressing any parameter affecting k values other than % B for some or all of the solutes and using the parameter in place of or in addition to % B.

15. The method of claim 10, wherein the desired separation goal is selected from the group consisting of minimizing analysis time, minimizing solvent usage, minimizing cost of analysis, maximizing detectability of solutes, maximizing resolution within a given analysis time, maximizing resolution within a solvent usage limit, maximizing production rate of a solute at column outlet at a stated level of purity from other sample components, minimizing production cost, and combinations thereof.

16. The method of claim 15, wherein step iv) is carried out by a method selected from the group consisting of full factorial analysis over the parameter values and coarse factorial analyses over more than one region of the parameter values.

17. A method for performing a multivariate optimization of a chromatographic separation, wherein the method comprises:
i) storing a relation between peak retention and effective solvent strength for each solute in a chromatogram,
ii) setting as a first default, a desired separation goal,
iii) setting as a second default, more than one chromatographic parameter, and
iv) searching through allowed values of the chromatographic parameters, and finding a combination of the values that produces the desired separation goal.

18. A method for modeling, predicting, and optimizing gradient elution high performance liquid chromatography separations, wherein the method comprises the steps of:
1) describing physical dimensions of a high performance liquid chromatography system;
2) collecting data from at least two isocratic separations, wherein the data comprise
a) retention time for an unretained marker as a function of mobile phase composition expressed as % B,
b) retention time for at least one solute peak of interest as a function of mobile phase composition expressed as % B, and
c) mobile phase pressure, wherein the isocratic separations are carried out at different % B values;
3) developing a relation between retention time expressed as log k and % B for the solute peak of interest in step 2), wherein the relation is developed by regression of the data collected in step 2);
4) predicting effects of parameter changes on the retention time of the solute peak of interest by a time segmented numerical analysis process comprising
i) performing a time segmented numerical analysis, wherein, within a given time segment, a strong component is presumed present in an amount that is constant;
ii) calculating distance the solute peak travels along the column during the given time segment and adding the distance to total distance the solute peak traveled along the column;
iii) incrementing the amount of the strong component to its next value in a successive time segment; and
iv) repeating steps i-iii) until the solute peak elutes;
5) predicting effects of parameter changes on peak widths of the solutes of interest using a modified time segmented numerical estimation approach comprising
i) performing a time segmented numerical analysis, wherein, within a given time segment, a strong component is presumed present in an amount that is constant;
ii) calculating contribution to broadening of the solute peak in the given time segment;
iii) correcting accumulated peak width for peak compression occurring when the amount of strong component relative to weak component changes during the chromatography program;
iv) incrementing the amount of the strong component to its next value in a successive time segment; and
v) repeating steps i-iv) until the solute peak elutes;
6) determining the mobile phase pressure necessary at column inlet to sustain flow rates investigated in steps 4) and 5) from the pressure data collected in step 2); and
7) performing a multivariate optimization of user-adjustable chromatographic parameters, wherein multivariate optimization is carried out by a method comprising
i) selecting a desired separation goal,
ii) identifying the chromatographic parameters,
iii) searching through allowed values of the chromatographic parameters, and finding a combination of the values that produces the desired separation goal.

19. The method of claim 18, wherein more than one solute peak of interest is present and wherein the method further comprises repeating steps 2-6 for each successive solute peak before step 7).

20. The method of claim 18, wherein steps 4) and 5) are carried out concurrently.

21. The method of claim 18, wherein the desired separation goal is selected from the group consisting of minimization of analysis time, minimization of solvent usage, maximizing detectability of the solutes, maximizing resolution within a given analysis time, maximizing resolution within a given solvent usage limit, maximizing production rate of a solute at a desired level of purity from other components, and minimizing production cost.

22. The method of claim 18, wherein step 7 iii) is carried out by method selected from the group consisting of a full factorial analysis in which the parameters are searched systematically at regular intervals over permissible ranges of all parameter values and coarse factorial analyses over more than one region of the parameter values.

23. A method for predicting high performance liquid chromatography separations, wherein the method comprises the steps of:
1) inputting data comprising
I) physical dimensions of a high performance liquid chromatography system;
II) data from at least two isocratic separations, wherein the data comprise
a) retention time for an unretained marker as a function of mobile phase composition expressed as % B,
b) retention time for at least one solute peak of interest as a function of mobile phase composition expressed as % B, and
c) mobile phase pressure, wherein the isocratic separations are carried out at different % B values;
2) transmitting the data input instep 1) to an internet web site, wherein the web site generates results using the data to model, predict, and optimize the separation by a process comprising
I) developing a relation between retention time expressed as log k and % B for the solute peak of interest in step 1), wherein the relation is developed by regression of the data input in step 1);
II) predicting effects of parameter changes on the retention time of the solute peak of interest by a time segmented numerical analysis process comprising
i) performing a time segmented numerical analysis, wherein, within a given time segment, a strong component is presumed present in an amount that is constant;
ii) calculating distance the solute peak travels along the column during the given time segment and adding the distance to total distance the solute peak traveled along the column;
iii) incrementing the amount of the strong component to its next value in a successive time segment; and
iv) repeating steps i-iii) until the solute peak elutes;
III) predicting effects of parameter changes on peak widths of the solutes of interest using a modified time segmented numerical estimation approach comprising
i) performing a time segmented numerical analysis, wherein, within a given time segment, a strong component is presumed present in an amount that is constant;
ii) calculating contribution to broadening of the solute peak in the given time segment;
iii) correcting accumulated peak width for peak compression occurring when the amount of strong component relative to weak component changes during the chromatography program;
iv) incrementing the amount of the strong component to its next value in a successive time segment; and
v) repeating steps i-iv) until the solute peak elutes;
IV) determining the mobile phase pressure necessary at column inlet to sustain flow rates investigated in steps 4) and 5) from the pressure data collected in step 2); and
V) performing a multivariate optimization of user-adjustable chromatographic parameters, wherein multivariate optimization is carried out by a method comprising
i) selecting a desired separation goal,
ii) identifying the chromatographic parameters,
iii) searching through allowed values of the chromatographic parameters, and finding a combination of the values that produces the desired separation goal; and
3) receiving the results generated in step 2).

24. The method of step 23, further comprising:
4) verifying the results by running a separation using the results received in step 3).

25. An article of manufacture comprising:
signal bearing media embodying a program of machine readable instructions executable by a data processor to perform method steps for modeling a chromatography separation, wherein the method steps comprise: i) performing a time segmented numerical analysis, wherein, within a given time segment, a strong component is presumed present in an amount that is constant;
ii) calculating contribution to broadening of a solute peak in the given time segment;
iii) correcting accumulated peak width for peak compression occurring when the amount of strong component relative to weak component changes during the chromatography program;
iv) incrementing the amount of the strong component to its next value in a successive time segment;
v) repeating steps i-iv) until the solute peak elutes; and
vi) displaying the accumulated peak width of the solute peak.

26. The article of claim 25, further comprising signal bearing media embodying a program of machine readable instructions executable by a data processor to perform a method step comprising: vii) repeating steps i-vi) for at least one successive solute peak.

27. The article of claim 26, further comprising signal bearing media embodying a program of machine readable instructions executable by a data processor to perform a method step comprising: calculating distance the solute peak travels along the column during the given time segment and adding the distance to total distance the solute peak traveled along the column.

28. The article of claim 27, further comprising signal bearing media embodying a program of machine readable instructions executable by a data processor to perform a method step comprising: interpolating in the last time segment to estimate retention time of the solute peak.

29. An article of manufacture comprising signal bearing media embodying a program of machine readable instructions executable by a data processor to perform method steps comprising:
i) developing a relation between peak retention and effective solvent strength for each solute in a chromatogram,
ii) storing a desired separation goal and identifying more than one operational parameters,
iii) searching through allowed values of the operational parameters, and finding a combination of the values that produces the desired separation goal.

30. An article of manufacture comprising signal bearing media embodying a program of machine readable instructions executable by a data processor to perform method steps for modeling a chromatography separation, wherein the method steps comprise
1) storing physical dimensions of a high performance liquid chromatography system;
2) collecting data from at least two isocratic separations, wherein the data comprise
a) retention time for an unretained marker as a function of mobile phase composition expressed as % B,
b) retention time for at least one solute peak of interest as a function of mobile phase composition expressed as % B, and
c) mobile phase pressure, wherein the isocratic separations are carried out at different % B values;
3) developing a relation between retention time expressed as log k and % B for the solute peak of interest in step 2), wherein the relation is developed by regression of the data collected in step 2);
4) predicting effects of parameter changes on the retention time of the solute peak of interest by a time segmented numerical analysis process comprising
i) performing a time segmented numerical analysis, wherein, within a given time segment, a strong component is presumed present in an amount that is constant;
ii) calculating distance the solute peak travels along the column during the given time segment and adding the distance to total distance the solute peak traveled along the column;
iii) incrementing the amount of the strong component to its next value in a successive time segment; and
iv) repeating steps i-iii) until the solute peak elutes;
5) predicting effects of parameter changes on peak widths of the solutes of interest using a modified time segmented numerical estimation approach comprising
i) performing a time segmented numerical analysis, wherein, within a given time segment, a strong component is presumed present in an amount that is constant;
ii) calculating contribution to broadening of the solute peak in the given time segment;
iii) correcting accumulated peak width for peak compression occurring when the amount of strong component relative to weak component changes during the chromatography program;
iv) incrementing the amount of the strong component to its next value in a successive time segment; and
v) repeating steps i-iv) until the solute peak elutes;
6) determining the mobile phase pressure necessary at column inlet to sustain flow rates investigated in steps 4) and 5) from the pressure data collected in step 2); and
7) performing a multivariate optimization of user-adjustable chromatographic parameters, wherein multivariate optimization is carried out by a method comprising
i) selecting a desired separation goal,
ii) identifying the chromatographic parameters,
iii) searching through allowed values of the chromatographic parameters, and finding a combination of the values that produces the desired separation goal.

31. The article of claim 30, wherein more than one solute peak of interest is present and wherein the article further comprises signal bearing media embodying a program of machine readable instructions executable by a data processor to perform a method step comprising repeating steps 2-6 for each successive solute peak before step 7).

32. An article of manufacture comprising signal bearing media embodying a program of machine readable instructions executable by a data processor to perform method steps comprising:
1) developing a mathematical model of a process, wherein the mathematical model comprises a relation between at least two operational parameters,
2) identifying variables within the model that affect the relation,
3) selecting at least one desired end result,
4) searching through allowed values of the identified variables, and finding a combination of the values that produces the desired end result.

33. The article according to any one of claims 25-32, wherein the signal bearing media is selected from the group consisting of transmission type media, recordable media, and internet web sites.

34. A method for developing a high performance liquid chromatography protocol comprising the steps of:
1) collecting data from initial laboratory experiments,
2) developing a mathematical model to predict retention time and peak width of a solute peak, wherein the model relates retention to mobile phase strength,
3) predicting retention time and peak width using the model developed in step 2),
4) performing a multivariate optimization of user adjustable parameters affecting retention time and peak width, and
5) implementing the optimized parameters in a high performance liquid chromatography system.
